(19) United States
(12) Patent Application Publication
(10) Pub. No.: US 2012/0106705 A1
(43) Pub. Date: May 3, 2012

(54) RADIOGRAPHIC APPARATUS AND RADIOGRAPHIC SYSTEM

(75) Inventors: Yuji MIKAMI, Kanagawa (JP); Hiroyasu ISHII, Kanagawa (JP)

(73) Assignee: FUJIFILM Corporation, Tokyo (JP)

(21) Appl. No.: 13/286,556

(22) Filed: Nov. 1, 2011

(30) Foreign Application Priority Data
Nov. 2, 2010 (JP) 2010-246775

(51) Int. Cl. G01N 23/20

(52) U.S. Cl. 378/70

(57) ABSTRACT

A radiographic apparatus includes a radiation source that irradiates radiation, a first grating unit, a grating pattern unit, a radiological image detector, and a support unit. The radiation irradiated from the radiation source passes through the first grating unit. The grating pattern unit includes a periodic form that has a period which substantially coincides with a pattern period of a radiological image formed by the radiation having passed through the first grating unit. The radiological image detector detects a masked radiological image which is formed by masking the radiological image by the grating pattern unit. The support unit supports the radiation source, the first grating unit, the grating pattern unit and the radiological image detector. The radiation source is attached to the support unit via a vibration-proof member.

### CROSS-REFERENCE TO RELATED APPLICATIONS

This application claims the benefit of Japanese Patent Application No. 2010-246775 (filed on Nov. 2, 2010), the entire contents of which are hereby incorporated by reference.

### BACKGROUND

1. Technical Field

The invention relates to a radiographic apparatus and a radiographic system.

2. Related Art

Since X-ray attenuates depending on an atomic number of an element configuring a material and a density and a thickness of the material, it is used as a probe for seeing through an inside of an object to be diagnosed. An imaging using the X-ray is widely spread in fields of medical diagnosis, nondestructive inspection and the like.

In a general X-ray imaging system, an object to be diagnosed is arranged between an X-ray source that irradiates the X-ray and an X-ray image detector that detects the X-ray and a transmission image of the object to be diagnosed is captured. In this case, the X-ray irradiated from the X-ray source toward the X-ray image detector is subject to the quantity attenuation (absorption) depending on differences of the material properties (for example, atomic numbers, densities and thickness) existing on a path to the X-ray image detector and is then incident onto each pixel of the X-ray image detector. As a result, an X-ray absorption image of the object to be diagnosed is detected and captured by the X-ray image detector. As the X-ray image detector, a flat panel detector (FPD) is widely used in addition to a combination of an X-ray intensifying screen and a film and a stimulable phosphor. As an X-ray source used in the X-ray imaging system, an X-ray source provided with the anode rotation type X-ray tube is widely used. (For example, JP-2010-044897)

However, the X-ray absorption ability is reduced in case of the material consisting of the element having the smaller atomic number. Accordingly, for soft biological tissue or soft material, it is not possible to acquire the shading (contrast) of an image that is enough for the X-ray absorption image. For example, the cartilaginous part and joint fluid configuring an articulation of the body are mostly comprised of water. Thus, since a difference of the X-ray absorption amounts thereof is small, it is difficult to obtain the shading difference.

Regarding the above problem, instead of the intensity change of the X-ray by the object to be diagnosed, a research on an X-ray phase imaging of obtaining an image (hereinafter, referred to as a phase contrast image) based on a phase change (angel change) of the X-ray by the object to be diagnosed has been actively carried out in recent years. In general, it has been known that when the X-ray is incident onto an object, the phase of the X-ray, rather than the intensity of the X-ray, shows the higher interaction. Accordingly, in the X-ray phase imaging of using the phase difference, it is possible to obtain a high contrast image even for a weak absorption material having low X-ray absorption ability. As the X-ray phase imaging, an X-ray imaging system has been recently suggested which uses an X-ray Talbot interferometer having two transmission diffraction gratings (phase type grating and absorption type grating) and an X-ray image detector (for example, refer to JP-A-2008-200360).

The X-ray Talbot interferometer includes a first diffraction grating (phase type grating or absorption type grating) that is arranged at a rear side of an object to be diagnosed, a second diffraction grating (absorption type grating) that is arranged downstream at a specific distance (Talbot interference distance) determined by a grating pitch of the first diffraction grating and an X-ray wavelength, and an X-ray image detector that is arranged at a rear side of the second diffraction grating. The Talbot interference distance is a distance in which the X-ray having passed through the first diffraction grating forms a self-image by the Talbot interference effect. The self-image is modulated by the interaction (phase change) of the object to be diagnosed, which is arranged between the X-ray source and the first diffraction grating, and the X-ray.

In the X-ray Talbot interferometer, a moiré fringe that is generated by superposition (intensity modulation) between the self-image of the first diffraction grating and the second diffraction grating is detected and a change of the moiré fringe by the object to be diagnosed is analyzed, so that phase information of the object to be diagnosed is acquired. As the analysis method of the moiré fringe, a fringe scanning method has been known. According to the fringe scanning method, a plurality of imaging is performed while the second diffraction grating is translation-moved with respect to the first diffraction grating in a direction, which is substantially parallel with a plane of the first diffraction grating and is substantially perpendicular to a grating direction (strip band direction) of the first diffraction grating, with a scanning pitch that is obtained by equally partitioning the grating pitch, and an angle distribution (differential image of a phase shift) of the X-ray refracted from the object to be diagnosed is acquired from changes of respective pixels obtained in the X-ray image detector. Based on the angle distribution, it is possible to acquire a phase contrast image of the object to be diagnosed.

However, a diffraction angle of the X-ray, which is caused at the time of passing through the photographic subject, is very small such as several μrad, and the change amount of the intensity modulation signal of the moiré fringe generated by the diffraction angle and the change of the signal, which is obtained by detecting the modulated moiré fringe by the fringe scanning method, are also very small. When measuring the slight change amounts, the difference of the relative position between the first diffraction grating and the second diffraction grating influences the detection accuracy of the phase information of the photographic subject.

The difference of the relative position between the first diffraction grating and the second diffraction grating may be generated due to vibrations that are applied to the first diffraction grating and the second diffraction grating. JP-A-2008-200360 discloses a configuration in which vibration from a table for a photographic subject is absorbed by a buffer material and thus the vibration transfer to the first diffraction grating and the second diffraction grating is blocked. However, in addition to the table for a photographic table, an X-ray source may be a vibration source, for example. In the X-ray source having the rotary anode type X-ray tube, the anode is rotated at high speed and the vibration is resultantly generated. However, JP-A-2008-200360 does not consider the vibration of the X-ray source and the difference of the relative position between the first diffraction grating and the second diffraction grating due to the vibration.

In the meantime, JP-2010-044897 discloses an X-ray source that has a rotary anode type X-ray tube and a housing accommodating the same, in which the X-ray tube is attached to the housing via a vibration-proof member and the vibration generated from the X-ray tube is thus suppressed from being transferred to the housing. Here, the X-ray source is generally provided with a cooling means for cooling the anode. For example, a cooling means having a fan is used. Typically, the cooling means is attached to the housing and the vibration is generated in the housing itself in association with rotation of the fan of the cooling means. The X-ray source disclosed in JP-2010-044897 cannot suppress the vibration that is generated in the housing itself, i.e., the vibration of the entire X-ray source.

When the X-ray focus and the first diffraction grating are relatively deviated in the translation-moving direction (x direction) of the second diffraction grating due to the vibration of the X-ray source, a self-image by the first diffraction grating blurs in the translation-moving direction at the position of the second diffraction grating. As a result, the contrast of the intensity modulation signal change that is detected by scanning the second diffraction grating is lowered, so that the phase detection accuracy by the fringe scanning method is deteriorated.

Also, appropriate grating pitches and grating intervals of the first diffraction grating and the second diffraction grating are related to the distance (z direction) from the focus and are determined by equations (1) and (2) that will be described later.

In addition, when the intervals of the X-ray focus and the first and second diffraction gratings in the z direction are relatively deviated due to the vibration of the X-ray source, the grating pitch and grating interval of the self-image of the first diffraction grating are deviated with respect to the grating pitch and grating interval of the second diffraction grating at the position of the second diffraction grating, so that a moiré is generated. This makes a difficult for the self-image of the first diffraction grating by the photographic subject to be separated from a phase shift, so that the detection accuracy of the phase information of the photographic subject is lowered.

Also, when any one relative position relation of gradients θx, θy and θz of the first and second diffraction gratings is deviated due to the vibration of the X-ray source, the grating pitch of the self-image of the first diffraction grating is deviated in at least one of the x and y directions with respect to the grating interval of the second diffraction grating at the position of the second diffraction grating, so that a moiré is generated. This makes a difficult for the self-image of the first diffraction grating by the photographic subject to be separated from a phase shift, so that the detection accuracy of the phase information of the photographic subject is lowered.

The invention has been made to solve the above problems. An object of the invention is to prevent a quality of a radiological phase contrast image from being deteriorated due to vibration of a radiation source such as X-ray source when performing a phase imaging by radiation such as X-ray.

### SUMMARY OF INVENTION

[1] According to an aspect of the invention, a radiographic apparatus includes a radiation source that irradiates radiation, a first grating unit, a grating pattern unit, a radiological image detector, and a support unit. The radiation irradiated from the radiation source passes through the first grating unit. The grating pattern unit includes a periodic form that has a period which substantially coincides with a pattern period of a radiological image formed by the radiation having passed through the first grating unit. The radiological image detector detects a masked radiological image which is formed by masking the radiological image by the grating pattern unit. The support unit supports the radiation source, the first grating unit, the grating pattern unit and the radiological image detector. The radiation source is attached to the support unit via a vibration-proof member.
[2] A radiographic system includes the radiographic apparatus of [1] and a calculation processing unit that calculates, from an image detected by the radiological image detector of the radiographic apparatus, a distribution of refraction angles of the radiation incident onto the radiological image detector and generates a phase contrast image of a photographic subject based on the distribution of the refraction angles.

According to the invention, the radiation source is attached to the support unit via a vibration-proof member. Thus, it is possible to prevent the vibration of the radiation source from being transferred to the first grating, the grating pattern and the radiological image detector, thereby improving the quality of the obtained radiological phase contrast image.

### BRIEF DESCRIPTION OF THE DRAWINGS

FIG. 1 is a pictorial view showing an example of a configuration of a radiographic system for illustrating an illustrative embodiment of the invention.

FIG. 2 is a perspective view of the radiographic system of FIG. 1.

FIG. 3 is a control block diagram of the radiographic system of FIG. 1.

FIG. 4 is a pictorial view showing a configuration of a radiological image detector of the radiographic system of FIG. 1.

FIG. 5 is a perspective view of an imaging unit of the radiographic system of FIG. 1.

FIG. 6 is a side view of the imaging unit of the radiographic system of FIG. 1.

FIGS. 7A to 7C are a pictorial views showing a mechanism for changing a period of a moiré fringe resulting from an overlapping of first and second gratings.

FIG. 8 is a pictorial view for illustrating refraction of radiation by a photographic subject.

FIG. 9 is a pictorial view for illustrating a fringe scanning method.

FIG. 10 is a graph showing pixel signals of the radiological image detector in accordance with the fringe scanning.

FIG. 11 is a pictorial view showing an example in which a radiation source of the radiographic system of FIG. 1 is supported.

FIG. 12 is a pictorial view showing another example of a configuration of a radiographic system for illustrating an illustrative embodiment of the invention.

FIG. 13 is a pictorial view showing a configuration of a modified embodiment of the radiographic system of FIG. 12.

FIG. 14 is a pictorial view showing a configuration of a modified embodiment of the radiographic system of FIG. 12.

FIG. 15 is a pictorial view showing another example of a radiographic system for illustrating an illustrative embodiment of the invention, in which a configuration of the radiological image detector thereof is shown.

FIG. 16 is a block diagram showing a configuration of a calculation unit that generates a radiological image, in accordance with another example of a radiographic system for illustrating an illustrative embodiment of the invention.

FIG. 17 is a graph showing pixel signals of a radiological image detector for illustrating a process in the calculation unit of the radiographic system shown in FIG. 16.

### DETAILED DESCRIPTION

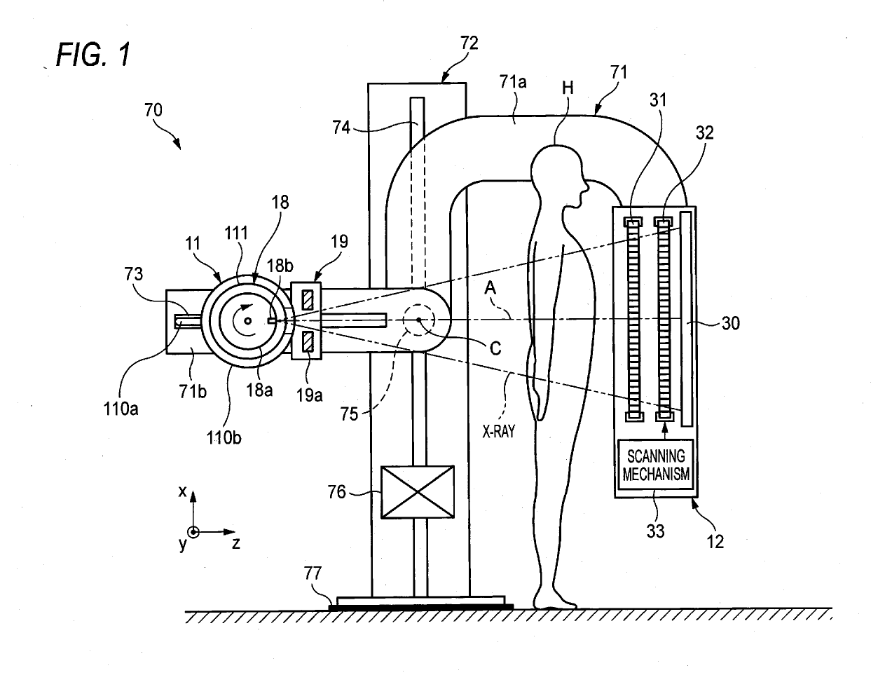

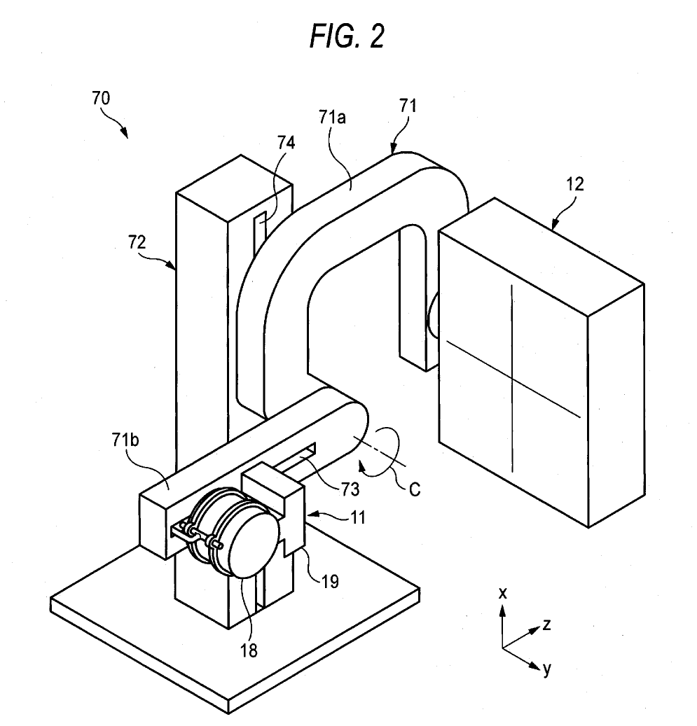

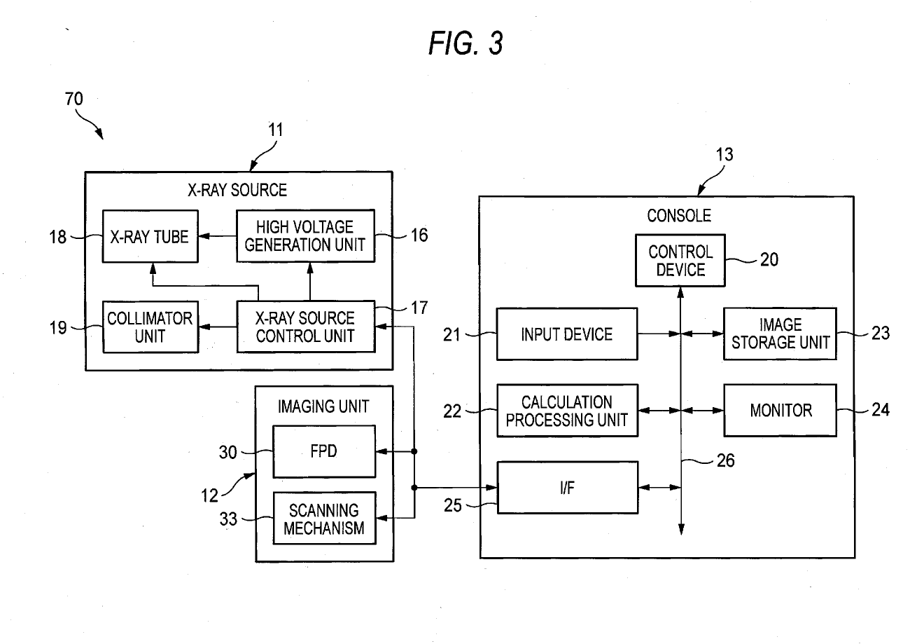

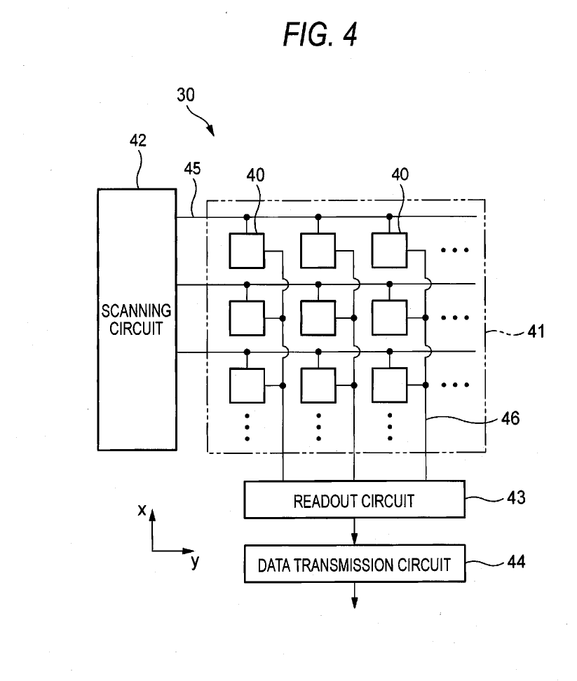

FIG. 1 shows an example of a configuration of a radiographic system for illustrating an illustrative embodiment of the invention, FIG. 2 is a perspective view of the radiographic system of FIG. 1 and FIG. 3 is a control block diagram of the radiographic system of FIG. 1.

An X-ray imaging system 70 is an X-ray diagnosis apparatus that performs an imaging for a photographic subject (patient) H while the patient stands, and includes an X-ray source 11 that X-radiates the photographic subject H, an imaging unit 12 that is opposed to the X-ray source 11, detects the X-ray having penetrated the photographic subject H from the X-ray source 11 and thus generates image data and a console 13 that controls an exposing operation of the X-ray source 11 and an imaging operation of the imaging unit 12 based on an operation of an operator, calculates the image data acquired by the imaging unit 12 and thus generates a phase contrast image.

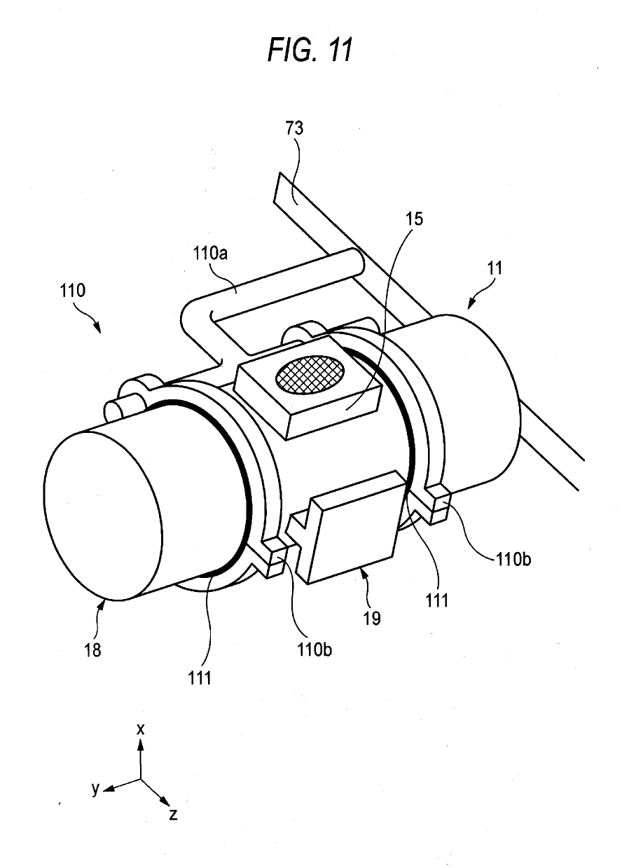

The X-ray source 11 includes an X-ray tube that generates the X-ray by a high voltage applied from a high voltage generator 16, based on control of an X-ray source control unit 17, a housing 18 having a substantially cylindrical shape that accommodates therein the X-ray tube, a collimator unit 19 having a moveable collimator 19a that limits an irradiation field so as to shield a part of the X-ray generated from the X-ray tube 18, which part does not contribute to an inspection area of the photographic subject H, and a cooling unit 15 (refer to FIG. 11). The X-ray tube is a rotary anode type X-ray tube that emits an electron beam from a filament (not shown) serving as an electron emission source (cathode) and collides the electron beam with a rotary anode 18a being rotating at predetermined speed, thereby generating the X-ray. A collision part of the electron beam of the rotary anode 18a is an X-ray focus 18b. In addition, the cooling unit 15 is attached to the housing 18 that accommodates therein the X-ray tube and has a fan for cooling the X-ray tube (refer to FIG. 11).

The imaging unit 12 is provided with a flat panel detector (FPD) 30 that consists of a semiconductor circuit, and a first absorption type grating 31 and a second absorption type grating 32 that detect a phase change (angle change) of the X-ray by the photographic subject H and performs a phase imaging.

The FPD 30 has a detection surface that is arranged to be orthogonal to an optical axis A of the X-ray irradiated from the X-ray source 11. As specifically described in the below, the first and second absorption type gratings 31, 32 are arranged between the FPD 30 and the X-ray source 11.

Also, the imaging unit 12 is provided with a scanning mechanism 33 that translation-moves the second absorption type grating 32 in the upper-lower direction (x direction) and thus changes a relative position relation of the second absorption type grating 32 to the first absorption type grating 31. The scanning mechanism 33 is configured by an actuator such as piezoelectric device and the like, for example.

The console 13 is provided with a control device 20 that includes a CPU, a ROM, a RAM and the like. The control device 20 is connected with an input device 21 with which an operator inputs an imaging instruction and an instruction content thereof, a calculation processing unit 22 that calculates the image data acquired by the imaging unit 12 and thus generates an X-ray image, a storage unit 23 that stores the X-ray image, a monitor 24 that displays the X-ray image and the like and an interface (I/F) 25 that is connected to the respective units of the X-ray imaging system 70, via a bus 26.

As the input device 21, a switch, a touch panel, a mouse, a keyboard and the like may be used, for example. By operating the input device 21, radiography conditions such as X-ray tube voltage, X-ray irradiation time and the like, an imaging timing and the like are input. The monitor 24 consists of a liquid crystal display and the like and displays letters such as X-ray imaging conditions and the X-ray image under control of the control device 20.

Also, in the X-ray imaging system 70, the X-ray source 11 and the imaging unit 12 are held by a rotational arm 71. The rotational arm 71 is rotatably connected to a base platform 72 that is mounted on the bottom.

The rotational arm 71 has a U-shaped part 71a having a substantially U shape and a linear part 71b that is connected to one end of the U-shaped part 71a. The other end of the U-shaped part 71a is mounted with the imaging unit 12. The linear part 71b is formed with a first recess 73 along the extending direction thereof. The X-ray source 11 is slidably mounted in the first recess 73 via an attachment unit 110. The X-ray source 11 and the imaging unit 12 are opposed to each other. By moving the X-ray source 11 along the first recess 73, it is possible to adjust a distance from the X-ray focus 18b to the detection surface of the FPD 30.

Also, the base platform 72 is formed with a second recess 74 extending in the upper-lower direction. The rotational arm 71 is adapted to vertically move along the second recess 74 by a connection mechanism 75 that is connected to the U-shaped part 71a and the linear part 71b. Also, the rotational arm 71 is adapted to rotate about a rotational axis C following the y direction by the connection mechanism 75. When the rotational arm 71 is 90°-rotated clockwise about the rotational axis C from the standing posture imaging state shown in FIG. 17 and the imaging unit 12 is arranged below a bed (not shown) on which the photographic subject H lies down, it is possible to perform the lying down posture imaging. In the meantime, the rotational arm 71 is not limited to the 90° rotation and can be rotated by a predetermined angle, so that it is possible to perform the imaging in any direction, in addition to the standing posture imaging (horizontal direction) and the lying down posture imaging (vertical direction).

Also, a buffer material 77 is provided between the base platform 72 and the bottom. As the buffer material, the rubber and the like may be used.

Thereby, it is possible to prevent the vibration of a high frequency, of the vibrations to be transferred from the bottom, from being transferred to the first and second absorption type gratings 31, 32 and the FPD 30 provided to the imaging unit 12 through the base platform 72 and the rotational arm 71. Hence, it is possible to the relative position of the first and second absorption type gratings 31, 32 from being deviated and thus to further improve the quality of the radiological phase contrast phase.

Also, a dynamic damper 76 that prevents or reduces the vibration to be transferred to the base platform 72 is provided. The dynamic damper 76 has a damper part that is designed to change an elastic coefficient, a weight part that is designed to change a weight, an attachment part and bolts that couples the damper part, the weight part and the attachment part. When the vibration is generated in the base platform 72, the damper part of the dynamic damper 76 is elastically deformed and the weight part that is attached via the damper part is vibrated. The elastic coefficient of the damper part of the dynamic damper 76 and the weight of the weight part are appropriately set depending on the vibration generated in the base platform 72 and the dynamic damper 76 is vibrated in a reverse phase relation to the vibration of the base platform 72, so that the vibration of the platform 72 is prevented or reduced. In the meantime, as the dynamic damper 76, the dynamic damper disclosed in JP-A-2009-101060 may be used.

Thereby, it is possible to prevent the vibration of a high frequency, of the vibrations to be transferred from the bottom, from being transferred to the first and second absorption type gratings 31, 32 and the FPD 30 provided to the imaging unit 12 through the base platform 72 and the rotational arm 71. Hence, it is possible to the relative position of the first and second absorption type gratings 31, 32 from being deviated and thus to further improve the quality of the radiological phase contrast phase.

In this illustrative embodiment, the X-ray source 11 and the imaging unit 12 are held by the rotational arm 71. Therefore, it is possible to set a distance from the X-ray source 11 to the imaging unit 12 easily and accurately.

In this illustrative embodiment, the imaging unit 12 is provided to the U-shaped part 71a and the X-ray source 11 is provided to the linear part 71b. However, like an X-ray diagnosis apparatus using a so-called C arm, the imaging unit 12 may be provided to one end of the C arm and the X-ray source 11 may be provided to the other end of the C arm.

FIG. 3 shows a configuration of the radiological image detector that is included in the radiographic system of FIG. 1.

The FPD 30 serving as the radiological image detector includes an image receiving unit 41 having a plurality of pixels 40 that converts and accumulates the X-ray into charges and is two-dimensionally arranged in the xy directions on an active matrix substrate, a scanning circuit 42 that controls a timing of reading out the charges from the image receiving unit 41, a readout circuit 43 that reads out the charges accumulated in the respective pixels 40 and converts and stores the charges into image data and a data transmission circuit 44 that transmits the image data to the calculation processing unit 22 through the I/F 25 of the console 13. Also, the scanning circuit 42 and the respective pixels 40 are connected by scanning lines 45 in each of rows and the readout circuit 43 and the respective pixels 40 are connected by signal lines 46 in each of columns.

Each pixel 40 can be configured as a direct conversion type element that directly converts the X-ray with a conversion layer (not shown) made of amorphous selenium and the like and accumulates the converted charges in a capacitor (not shown) connected to a lower electrode of the conversion layer. Each pixel 40 is connected with a TFT switch (not shown) and a gate electrode of the TFT switch is connected to the scanning line 45, a source electrode is connected to the capacitor and a drain electrode is connected to the signal line 46. When the TFT switch turns on by a driving pulse from the scanning circuit 42, the charges accumulated in the capacitor are read out to the signal line 46.

In addition, each pixel 40 may be also configured as an indirect conversion type X-ray detection element that converts the X-ray into visible light with a scintillator (not shown) made of gadolinium oxide (Gd2O3), cesium iodide (CsI) and the like and then converts and accumulates the converted visible light into charges with a photodiode (not shown). Also, the X-ray image detector is not limited to the FPD based on the TFT panel. For example, a variety of X-ray image detectors based on a solid imaging device such as CCD sensor, CMOS sensor and the like may be also used.

The readout circuit 43 includes an integral amplification circuit, an A/D converter, a correction circuit and an image memory, which are not shown. The integral amplification circuit integrates and converts the charges output from the respective pixels 40 through the signal lines 46 into voltage signals (image signals) and inputs the same into the A/D converter. The A/D converter converts the input image signals into digital image data and inputs the same to the correction circuit. The correction circuit performs an offset correction, a gain correction and a linearity correction for the image data and stores the image data after the corrections in the image memory. Also, the correction process of the correction circuit may include a correction of an exposure amount and an exposure distribution (so-called shading) of the X-ray, a correction of a pattern noise (for example, a leak signal of the TFT switch) depending on control conditions (driving frequency, readout period and the like) of the FPD 30, and the like.

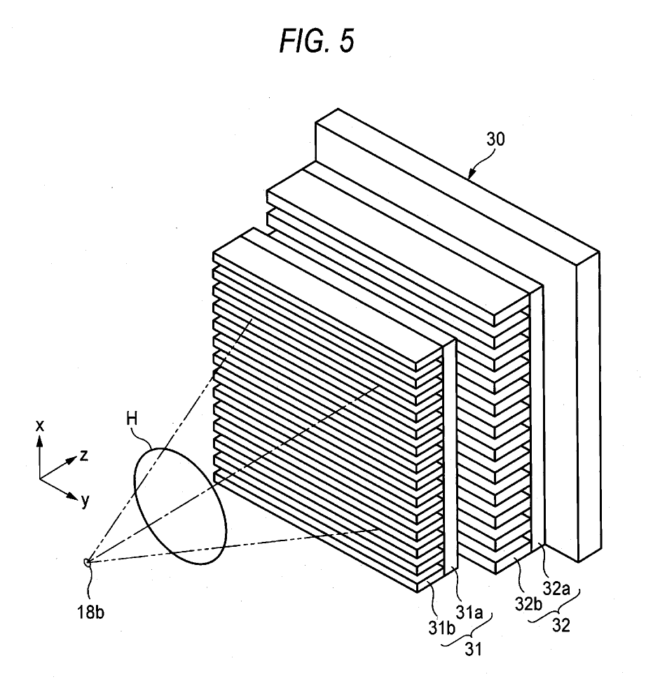

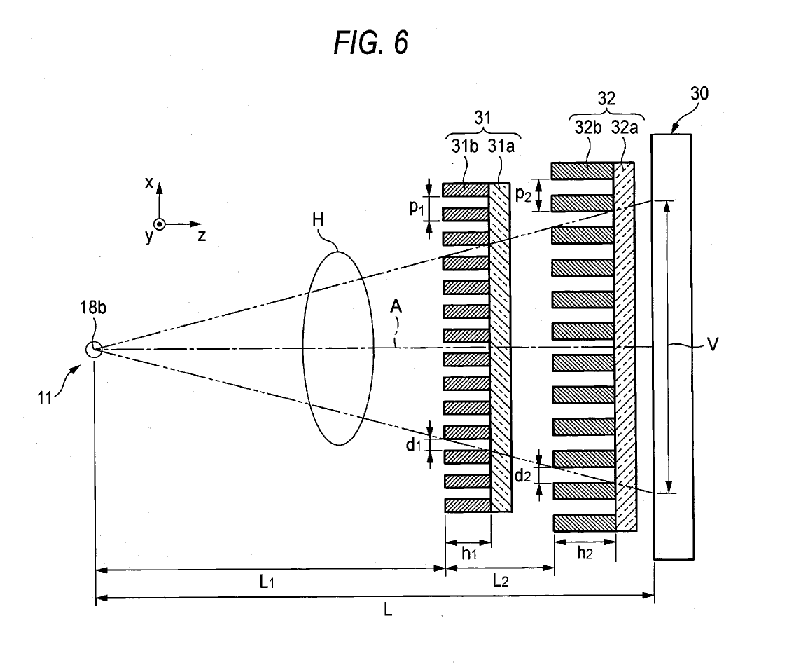

FIGS. 5 and 6 show the imaging unit of the radiographic system shown in FIG. 1. The first absorption type grating 31 has a substrate 31a and a plurality of X-ray shield units 31b arranged on the substrate 31a. Likewise, the second absorption type grating 32 has a substrate 32a and a plurality of X-ray shield units 32b arranged on the substrate 32a. The substrates 31a, 32a are configured by radiolucent members through which the X-ray penetrates, such as glass.

The X-ray shield units 31b, 32b are configured by linear members extending in in-plane one direction (in the shown example, a y direction orthogonal to the x and z directions) orthogonal to the optical axis A of the X-ray irradiated from the X-ray source 11. As the materials of the respective X-ray shield units 31b, 32b, materials having excellent X-ray absorption ability are preferable. For example, the heavy metal such as gold, platinum and the like is preferable. The X-ray shield units 31b, 32b can be formed by the metal plating or deposition method.

The X-ray shield units 31b are arranged on the in-plane orthogonal to the optical axis A of the X-ray with a constant cycle p1 and at a predetermined interval d1 in the direction (x direction) orthogonal to the one direction. Likewise, the X-ray shield units 32b are arranged on the in-plane orthogonal to the optical axis A of the X-ray with a constant cycle p2 and at a predetermined interval d2 in the direction (x direction) orthogonal to the one direction. Since the first and second absorption type gratings 31, 32 provide the incident X-ray with an intensity difference, rather than the phase difference, they are also referred to as amplitude type gratings. Also, the slit (area of the interval d1 or d2) may not be a void. For example, the void may be filled with X-ray low absorption material such as high molecule or light metal.

The first and second absorption type gratings 31, 32 are adapted to geometrically image the X-ray having passed through the slits, regardless of the Talbot interference effect. Specifically, the intervals d1, d2 are set to be sufficiently larger than a peak wavelength of the X-ray irradiated from the X-ray source 11, so that most of the X-ray included in the irradiated X-ray is enabled to pass through the slits while keeping the linearity, without being diffracted in the slits. For example, when the rotary anode 18a is made of tungsten and the tube voltage is 50 kV, the peak wavelength of the X-ray is about 0.4 Å. In this case, when the intervals d1, d2 are set to be about 1 to 10 μm, most of the X-ray is geometrically projected in the slits while the X-ray is not diffracted therein.

Since the X-ray irradiated from the X-ray source 11 is a conical beam having the X-ray focus 18b as an emitting point, rather than a parallel beam, a projection image (hereinafter, referred to as G1 image), which has passed through the first absorption type grating 31 and is projected, is enlarged in proportion to a distance from the X-ray focus 18b. The grating pitch p2 and the interval d2 of the second absorption type grating 32 are determined so that the slits substantially coincide with a periodic pattern of bright parts of the G1 image at the position of the second absorption type grating 32. That is, when a distance from the X-ray focus 18b to the first absorption type grating 31 is L1 and a distance from the first absorption type grating 31 to the second absorption type grating 32 is L2, the grating pitch p2 and the interval d2 are determined to satisfy following equations (1) and (2).

$$\begin{matrix}[ equation 1 ] & \\ {p}_{2} = \frac{{L}_{1} + {L}_{2}}{{L}_{1}} {p}_{1} & ( 1 ) \\ [ equation 2 ] & \\ {d}_{2} = \frac{{L}_{1} + {L}_{2}}{{L}_{1}} {d}_{1} & ( 2 )\end{matrix}$$

In the Talbot interferometer, the distance L2 from the first absorption type grating 31 to the second absorption type grating 32 is restrained with a Talbot interference distance that is determined by a grating pitch of a first diffraction grating and an X-ray wavelength. However, in the X-ray imaging system 70 of the invention, since the first absorption type grating 31 projects the incident X-ray without diffracting the same and the G1 image of the first absorption type grating 31 is similarly obtained at all positions of the rear of the first absorption type grating 31, it is possible to set the distance L2 irrespective of the Talbot interference distance.

Although the imaging unit 12 does not configure the Talbot interferometer, as described above, a Talbot interference distance Z that is obtained if the first absorption type grating 31 diffracts the X-ray is expressed by a following equation (3) using the grating pitch p1 of the first absorption type grating 31, the grating pitch p2 of the second absorption type grating 32, the X-ray wavelength (peak wavelength) λ and a positive integer m.

$$\begin{matrix}[ equation 3 ] & \\ Z = m \frac{{p}_{1} {p}_{2}}{λ} & ( 3 )\end{matrix}$$

The equation (3) indicates a Talbot interference distance when the X-ray irradiated from the X-ray source 11 is a conical beam and is known in “Atsushi Momose, et al., Japanese Journal of Applied Physics, Vol. 47, No. 10, 2008, August, page 8077).

In the X-ray imaging system (70), the distance L2 is set to be shorter than the minimum Talbot interference distance Z when m=1 so as to make the imaging unit 12 thin. That is, the distance L2 is set by a value within a range satisfying a following equation (4).

$$\begin{matrix}[ equation 4 ] & \\ {L}_{2} < \frac{{p}_{1} {p}_{2}}{λ} & ( 4 )\end{matrix}$$

In addition, when the X-ray irradiated from the X-ray source 11 can be considered as a substantially parallel beam, the Talbot interference distance Z is expressed by a following equation (5) and the distance L2 is set by a value within a range satisfying a following equation (6).

$$\begin{matrix}[ equation 5 ] & \\ Z = m \frac{{p}_{1}^{2}}{λ} & ( 5 ) \\ [ equation 6 ] & \\ {L}_{2} < \frac{{p}_{1}^{2}}{λ} & ( 6 )\end{matrix}$$

In order to generate a periodic pattern image having high contrast, it is preferable that the X-ray shield units 31b, 32b perfectly shield (absorb) the X-ray. Even when the materials (gold, platinum and the like) having excellent X-ray absorption ability are used, many X-ray penetrates the X-ray shield units. Accordingly, in order to improve the shield ability of X-ray, it is preferable to make thickness h1, h2 of the X-ray shield units 31b, 32b thicker as much as possible, respectively. For example, when the tube voltage of the X-ray tube is 50 kV, it is preferable to shield 90% or more of the irradiated X-ray. In this case, the thickness h1, h2 are preferably 30 μm or larger, based on gold (Au).

In the meantime, when the thickness h1, h2 of the X-ray shield units 31b, 32b are excessively thickened, it is difficult for the obliquely incident X-ray to pass through the slits. Thereby, the so-called vignetting occurs, so that an effective field of view of the direction (x direction) orthogonal to the extending direction of the X-ray shield units 31b, 32b is narrowed. Therefore, from a standpoint of securing the field of view, the upper limits of the thickness h1, h2 are defined. In order to secure a length V of the effective field of view in the x direction on the detection surface of the FPD 30, when a distance from the X-ray focus 18b to the detection surface of the FPD 30 is L, the thickness h1, h2 are necessarily set to satisfy following equations (7) and (8), from a geometrical relation shown in FIG. 6.

$$\begin{matrix}[ equation 7 ] & \\ {h}_{1} \leq \frac{L}{V / 2} {d}_{1} & ( 7 ) \\ [ equation 8 ] & \\ {h}_{2} \leq \frac{L}{V / 2} {d}_{2} & ( 8 )\end{matrix}$$

For example, when d1=2.5 μm, d2=3.0 μm and L=2 m, assuming a typical diagnose in a hospital, the thickness h1 should be 100 μm or smaller and the thickness h2 should be 120 μm or smaller so as to secure a length of 10 cm as the length V of the effective field of view in the x direction.

In the first and second absorption type gratings 31 and 32 configured as described above, when the photographic subject H is not placed, an intensity-modulated image is formed by the superimposition of the G1 image of the first absorption type grating 31 and the second absorption type grating 32 and is captured by the FPD 30. A pattern period p1′ of the G1 image at the position of the second absorption type grating 32 and a substantial grating pitch p2′ of the second absorption type grating 32 (substantial pitch after the manufacturing) are slightly different due to the manufacturing error or arrangement error. The arrangement error means that the substantial pitches of the first and second absorption type gratings 31, 32 in the x direction are changed as the inclination, rotation and the interval therebetween are relatively changed.

Due to the slight difference between the pattern period p1′ of the G1 image and the grating pitch p2′, the image contrast becomes a moiré fringe. A period T of the moiré fringe is expressed by a following equation (9).

$$\begin{matrix}[ equation 9 ] & \\ T = \frac{p {1}^{′} \times p {2}^{′}}{\vert p {1}^{′} - p {2}^{′} \vert} & ( 9 )\end{matrix}$$

When it is intended to detect the moiré fringe with the FPD 30, an arrangement pitch P of the pixels 40 in the x direction should satisfy at least a following equation (10) and preferably satisfy a following equation (11) (n: positive integer).

[equation 10]

P≠nT (10)

[equation 11]

P<T (11)

The equation (10) means that the arrangement pitch P is not an integer multiple of the moiré period T. Even for a case of n>2, it is possible to detect the moiré fringe in principle. The equation (11) means that the arrangement pitch P is set to be smaller than the moiré period T.

Since the arrangement pitch P of the pixels 40 of the FPD 30 are design-determined (in general, about 100 μm) and it is difficult to change the same, when it is intended to adjust a magnitude relation of the arrangement pitch P and the moiré period T, it is preferable to adjust the positions of the first and second absorption type gratings 31, 32 and to change at least one of the pattern period p1′ of the G1 image and the grating pitch p2′, thereby changing the moiré period T.

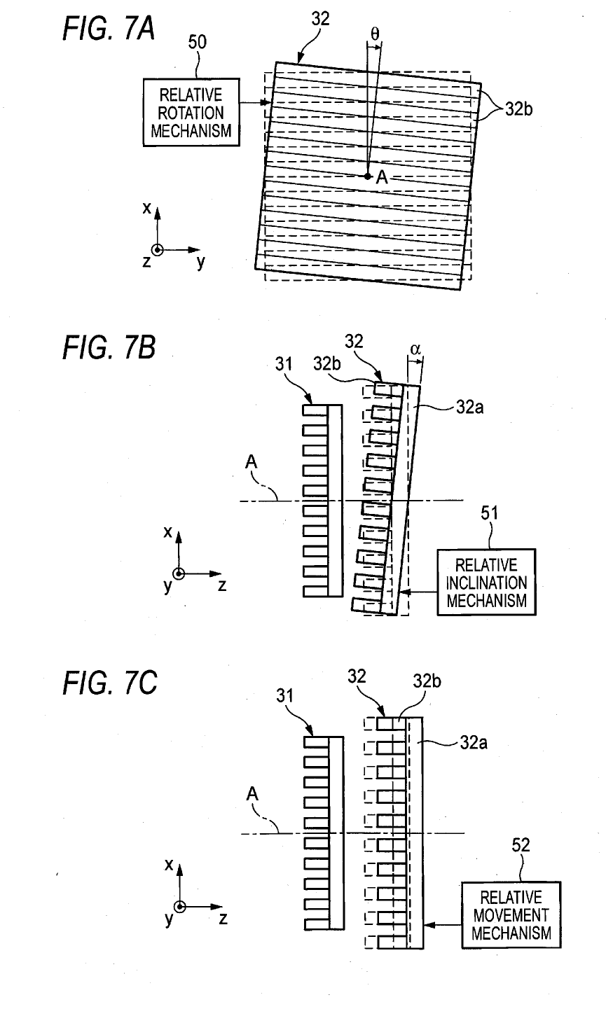

FIGS. 7A to 7C show a method of changing the moiré period T.

It is possible to change the moiré period T by relatively rotating one of the first and second absorption type gratings 31, 32 about the optical axis A. For example, there is provided a relative rotation mechanism 50 that rotates the second absorption type grating 32 relatively to the first absorption type grating 31 about the optical axis A. When the second absorption type grating 32 is rotated by an angle θ by the relative rotation mechanism 50, the substantial grating pitch in the x direction is changed from “p2′” to “p2′/cos θ”, so that the moiré period T is changed (refer to FIG. 7A).

As another example, it is possible to change the moiré period T by relatively inclining one of the first and second absorption type gratings 31, 32 about an axis orthogonal to the optical axis A and following the y direction. For example, there is provided a relative inclination mechanism 51 that inclines the second absorption type grating 32 relatively to the first absorption type grating 31 about an axis orthogonal to the optical axis A and following the y direction. When the second absorption type grating 32 is inclined by an angle α by the relative inclination mechanism 51, the substantial grating pitch in the x direction is changed from “p2′” to “p2′×cos θ”, so that the moiré period T is changed (refer to FIG. 7B).

As another example, it is possible to change the moiré period T by relatively moving one of the first and second absorption type gratings 31, 32 along a direction of the optical axis A. For example, there is provided a relative movement mechanism 52 that moves the second absorption type grating 32 relatively to the first absorption type grating 31 along a direction of the optical axis A so as to change the distance L2 between the first absorption type grating 31 and the second absorption type grating 32. When the second absorption type grating 32 is moved along the optical axis A by a movement amount δ by the relative movement mechanism 52, the pattern period of the G1 image of the first absorption type grating 31 projected at the position of the second absorption type grating 32 is changed from “p1′” to “p1′×(L1+L2+δ)/(L1+L2)”, so that the moiré period T is changed (refer to FIG. 7C).

In the X-ray imaging system 70, since the imaging unit 12 is not the Talbot interferometer and can freely set the distance L2, it can appropriately adopt the mechanism for changing the distance L2 and to thus change the moiré period T, such as the relative movement mechanism 52. The changing mechanisms (the relative rotation mechanism 50, the relative inclination mechanism 51 and the relative movement mechanism 52) of the first and second absorption type gratings 31, 32 for changing the moiré period T can be configured by actuators such as piezoelectric devices.

When the photographic subject H is arranged between the X-ray source 11 and the first absorption type grating 31, the moiré fringe that is detected by the FPD 30 is modulated by the photographic subject H. An amount of the modulation is proportional to the angle of the X-ray that is deviated by the refraction effect of the photographic subject H. Accordingly, it is possible to generate the phase contrast image of the photographic subject H by analyzing the moiré fringe detected by the FPD 30.

In the below, an analysis method of the moiré fringe is described.

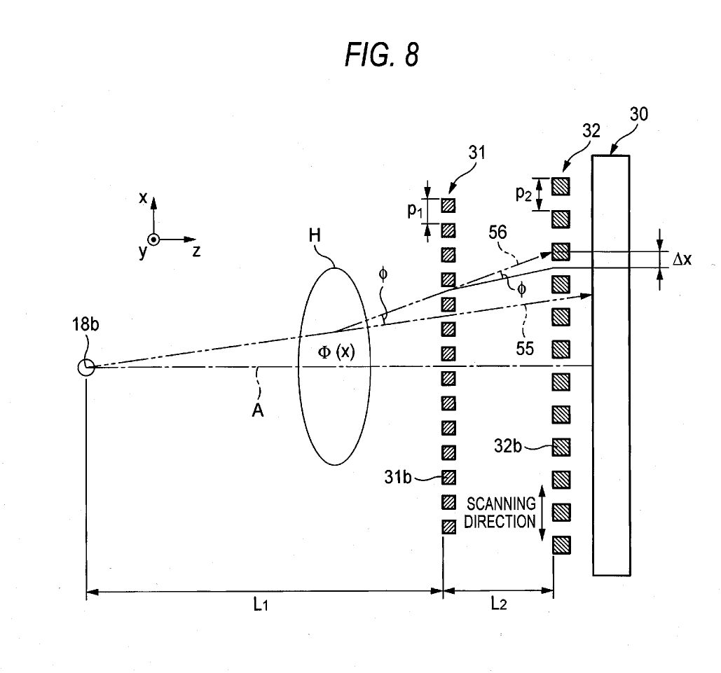

FIG. 8 shows one X-ray that is refracted in correspondence to a phase shift distribution Φ(x) in the x direction of the photographic subject H. In FIG. 8, an anti-scatter grid is omitted.

A reference numeral 55 indicates a path of the X-ray that goes straight when there is no photographic subject H. The X-ray traveling along the path 55 passes through the first and second absorption type gratings 31, 32 and is then incident onto the FPD 30. A reference numeral 56 indicates a path of the X-ray that is refracted and deviated by the photographic subject H. The X-ray traveling along the path 56 passes through the first absorption type grating 31 and is then shielded by the second absorption type grating 32.

The phase shift distribution Φ(x) of the photographic subject H is expressed by a following equation (12), when a refractive index distribution of the photographic subject H is indicated by n(x, z) and the traveling direction of the X-ray is indicated by Z.

$$\begin{matrix}[ equation 12 ] & \\ Φ ( x ) = \frac{2 π}{λ} \int [ 1 - n ( x , z ) ] d z & ( 12 )\end{matrix}$$

The G1 image that is projected from the first absorption type grating 31 to the position of the second absorption type grating 32 is displaced in the x direction as an amount corresponding to a refraction angle φ, due to the refraction of the X-ray at the photographic subject H. An amount of displacement Δx is approximately expressed by a following equation (13), based on the fact that the refraction angle φ of the X-ray is slight.

[equation 13]

Δx≈L₂φ (13)

Here, the refraction angle φ is expressed by an equation (14) by using a wavelength λ of the X-ray and the phase shift distribution Φ(x) of the photographic subject H.

$$\begin{matrix}[ equation 14 ] & \\ ϕ = \frac{λ}{2 π} \frac{\partial Φ ( x )}{\partial x} & ( 14 )\end{matrix}$$

Like this, the amount of displacement Δx of the G1 image due to the refraction of the X-ray at the photographic subject H is related to the phase shift distribution Φ(x) of the photographic subject H. Also, the amount of displacement Δx is related to a phase difference amount ψ of a signal output from each pixel 40 of the FPD 40 (a difference amount of phase between a phase of a signal of each pixel 40 when there is the photographic subject H and a phase of a signal of each pixel 40 when there is no photographic subject H), as expressed by a following equation (15).

$$\begin{matrix}[ equation 15 ] & \\ ψ = \frac{2 π}{{p}_{2}} Δ x = \frac{2 π}{{p}_{2}} {L}_{2} ϕ & ( 15 )\end{matrix}$$

Therefore, when the phase difference amount ψ of a signal of each pixel 40 is calculated, the refraction angle φ is obtained from the equation (15) and a differential of the phase shift distribution Φ(x) is obtained by using the equation (14). Hence, by integrating the differential with respect to x, it is possible to generate the phase shift distribution Φ(x) of the photographic subject H, i.e., the phase contrast image of the photographic subject H. In the X-ray imaging system 70 of this illustrative embodiment, the phase difference amount ψ is calculated by using a fringe scanning method that is described below.

In the fringe scanning method, an imaging is performed while one of the first and second absorption type gratings 31, 32 is stepwise translation-moved relatively to the other in the x direction (that is, an imaging is performed while changing the phases of the grating periods of both gratings). In the X-ray imaging system 70 of this illustrative embodiment, the second absorption type grating 32 is moved by the scanning mechanism 33. However, the first absorption type grating 31 may be moved. As the second absorption type grating 32 is moved, the moiré fringe is moved. When the translation distance (movement amount in the x direction) reaches one period (grating pitch p2) of the grating period of the second absorption type grating 32 (i.e., when the phase change reaches 2π), the moiré fringe returns to its original position. Regarding the change of the moiré fringe, while moving the second absorption type grating 32 by 1/n (n: integer) with respect to the grating pitch p2, the fringe images are captured in the FPD 30 and the signals of the respective pixels 40 are obtained from the captured fringe images and calculated in the calculation processing unit 22, so that the phase difference amount ψ of the signal of each pixel 40 is obtained.

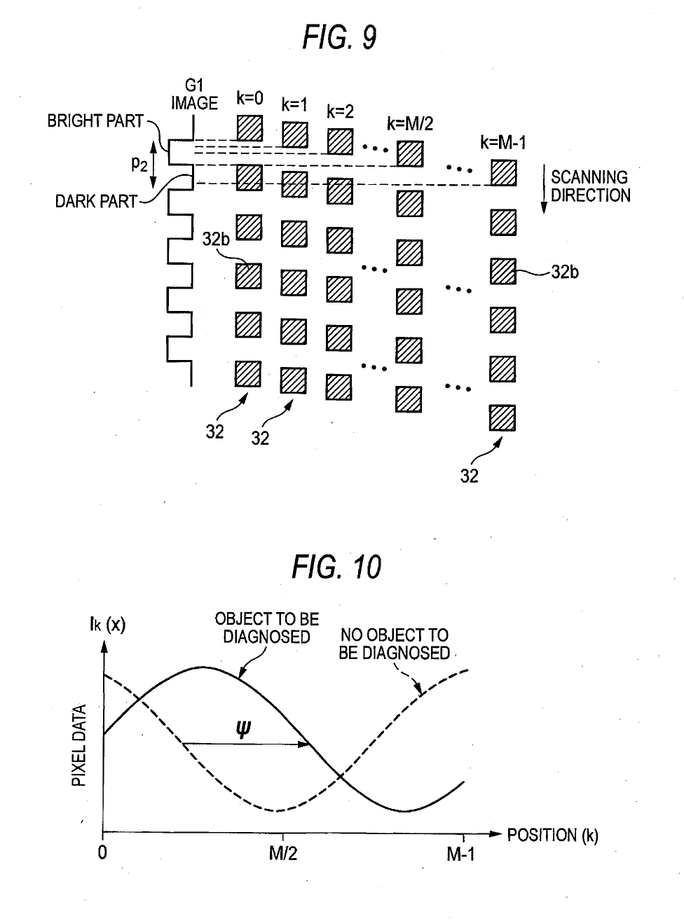

FIG. 9 pictorially shows that the second absorption type grating 32 is moved by a scanning pitch (p2/M) that is obtained by dividing the grating pitch p2 into M (M: integer of 2 or larger).

The scanning mechanism 33 sequentially translation-moves the second absorption type grating 32 at each of M scanning positions of k=0, 1, 2, . . . , M−1. In FIG. 9, an initial position of the second absorption type grating 32 is a position (k=0) at which a dark part of the G1 image at the position of the second absorption type grating 32 when there is no photographic subject H substantially coincides with the X-ray shield unit 32b. However, the initial position may be any position of k=0, 1, 2, . . . , M−1.

First, at the position of k=0, mainly, the X-ray that is not refracted by the photographic subject H passes through the second absorption type grating 32. Then, when the second absorption type grating 32 is moved in order of k=1, 2, . . . , regarding the X-ray passing through the second absorption type grating 32, the component of the X-ray that is not refracted by the photographic subject H is decreased and the component of the X-ray that is refracted by the photographic subject H is increased. In particular, at the position of k=M/2, mainly, only the X-ray that is refracted by the photographic subject H passes through the second absorption type grating 32. At the position exceeding k=M/2, contrary to the above, regarding the X-ray passing through the second absorption type grating 32, the component of the X-ray that is refracted by the photographic subject H is decreased and the component of the X-ray that is not refracted by the photographic subject H is increased.

At each position of k=0, 1, 2, . . . , M−1, when the imaging is performed by the FPD 30, M signal values are obtained for the respective pixels 40. In the below, a method of calculating the phase difference amount ψ of the signal of each pixel 40 from the M signal values is described. When a signal value of each pixel 40 at the position k of the second absorption type grating 32 is indicated with Ik(x), Ik(x) is expressed by a following equation (16).

$$\begin{matrix}[ equation 16 ] & \\ {I}_{k} ( x ) = {A}_{0} + {\sum }_{n > 0}^{ } {A}_{n} exp [ 2 π i \frac{n}{{p}_{2}} \{ {L}_{2} ϕ ( x ) + \frac{{kp}_{2}}{M} \} ] & ( 16 )\end{matrix}$$

Here, x is a coordinate of the pixel 40 in the x direction, A0 is the intensity of the incident X-ray and An is a value corresponding to the contrast of the signal value of the pixel 40 (n is a positive integer). Also, φ(x) indicates the refraction angle φ as a function of the coordinate x of the pixel 40.

When a following equation (17) is used, the refraction angle φ(x) is expressed by a following equation (18).

$$\begin{matrix}[ equation 17 ] & \\ {\sum }_{k = 0}^{M - 1} exp ( - 2 π i \frac{k}{M} ) = 0 & ( 17 ) \\ [ equation 18 ] & \\ ϕ ( x ) = \frac{{p}_{2}}{2 π {L}_{2}} arg [ {\sum }_{K = 0}^{M - 1} {I}_{k} ( x ) exp ( - 2 π i \frac{k}{M} ) ] & ( 18 )\end{matrix}$$

Here, arg[ ] is a symbol of an operation which means the calculation of an argument. The calculated argument corresponds to the phase difference amount ψ of the signal in each pixel 40. Therefore, from the M signal values obtained from the respective pixels 40, the phase difference amount ψ of the signal of each pixel 40 is calculated based on the equation (18), and the refraction angle φ(x) is acquired.

FIG. 10 shows a signal of one pixel of the radiological image detector, which is changed depending on the fringe scanning.

The M signal values obtained from the respective pixels 40 are periodically changed with the period of the grating pitch p2 with respect to the position k of the second absorption type grating 32. The dotted line of FIG. 10 indicates the change of the signal value when there is no photographic subject H and the solid line of FIG. 10 indicates the change of the signal value when there is the photographic subject H. A phase difference of both waveforms corresponds to the phase difference amount ψ of the signal of each pixel 40.

Since the refraction angle φ(x) is a value corresponding to the differential phase value, as shown with the equation (14), the phase shift distribution Φ(x) is obtained by integrating the refraction angle φ(x) along the x axis. While the y coordinates with respect to the y direction of the pixels 40 are not considered in the above explanation, a phase shift distribution Φ(x, y) may be obtained by operating the same kind calculations in the y coordinate

The above calculations are performed by the calculation processing unit 22 and the calculation processing unit 22 stores the phase contrast image in the storage unit 23.

After the operator inputs the imaging instruction through the input device 21, the respective units operate in cooperation with each other under control of the control device 20, so that the fringe scanning and the generation process of the phase contrast image are automatically performed and the phase contrast image of the photographic subject H is finally displayed on the monitor 24.

FIG. 11 shows an example in which the radiation source of the radiographic system of FIG. 1 is supported. As the housing 18 of the X-ray source 11 is attached to the attachment unit 110, the X-ray source 11 is mounted to the linear part 71b of the rotational arm 71. The attachment unit 110 has a holding ring support part 110a and a plurality of holding rings 110b. The holding ring support part 110a has a first L-shaped shaft portion having one end fitted into the recess 73 and extending in y and z directions and a second shaft portion connected to the other end of the first shaft portion and symmetrically extending in the y and −y directions. The holding rings 110b that hold the housing 18 are attached to both ends of the second shaft portion of the holding ring support part 110a. The holding rings 11b are adapted to open and close at the second shaft portion of the holding ring support part 110a to which the holding rings 110b are attached and which second shaft portion serves as a support point. Thereby, the housing 18 (X-ray source 11) that accommodates therein the X-ray tube is detachably mounted to the holding rings 110b.

The holding rings 110b hold the housing 18 via vibration-proof materials 111. That is, the vibration-proof materials 111 having a predetermined width in the y direction are provided to surround the housing 118 in a circumferential direction thereof and the holding rings 110b are provided to surround the vibration-proof materials 111. As the vibration-proof materials 111, the rubber and the like may be used.

Like this, the X-ray source 11 is held via the vibration-proof materials 111. Therefore, even when the vibration is generated in the X-ray source 11 in association with the rotation of the rotary anode 18a or fan of the cooling unit 15, it is possible to prevent the vibration from being transferred to the first and second absorption type gratings 31, 32 and the FPD 30 of the imaging unit 12 through the rotational arm 71. Thereby, it is possible to prevent the relative position of the first and second absorption type gratings 31, 32 from being deviated and to thus improve the quality of the radiological phase contrast image. Also, the holding rings 110b hold the housing 18, which accommodates therein the X-ray tube, over the entire circumference thereof, so that it is possible to securely fix the X-ray source 11 and to thus suppress the vibration of the X-ray source 11.

Also, the X-ray is not mostly diffracted at the first absorption type grating 31 and is geometrically projected to the second absorption type grating 32. Accordingly, it is not necessary for the irradiated X-ray to have high spatial coherence and thus it is possible to use a general X-ray source that is used in the medical fields, as the X-ray source 11. In the meantime, since it is possible to arbitrarily set the distance L2 from the first absorption type grating 31 to the second absorption type grating 32 and to set the distance L2 to be smaller than the minimum Talbot interference distance of the Talbot interferometer, it is possible to miniaturize the imaging unit 12. Further, in the X-ray imaging system 70 of this illustrative embodiment, since the substantially entire wavelength components of the irradiated X-ray contribute to the projection image (G1 image) from the first absorption type grating 31 and the contrast of the moiré fringe is improved, it is possible to improve the detection sensitivity of the phase contrast image.

Also, in the X-ray imaging system 70, the refraction angle φ is calculated by performing the fringe scanning for the projection image of the first grating. Thus, it has been described that the first and second gratings are the absorption type gratings. However, the invention is not limited thereto. As described above, the invention is useful even when the refraction angle φ is calculated by performing the fringe scanning for the Talbot interference image. Accordingly, the first grating is not limited to the absorption type grating and may be a phase type grating. Also, the analysis method of the moiré fringe that is formed by the superimposition of the X-ray image of the first grating and the second grating is not limited to the above fringe scanning method. For example, a variety of methods using the moiré fringe such as method of using Fourier transform/inverse Fourier transform known in “J. Opt. Soc. Am. Vol. 72, No. 1 (1982) p. 156” may be also applied.

Also, it has been described that the X-ray imaging system 70 stores or displays, as the phase contrast image, the image based on the phase shift distribution Φ. However, as described above, the phase shift distribution Φ is obtained by integrating the differential of the phase shift distribution Φ obtained from the refraction angle φ, and the refraction angle φ and the differential of the phase shift distribution Φ are also related to the phase change of the X-ray by the photographic subject. Accordingly, the image based on the refraction angle φ and the image based on the differential of the phase shift distribution Φ are also included in the phase contrast image.

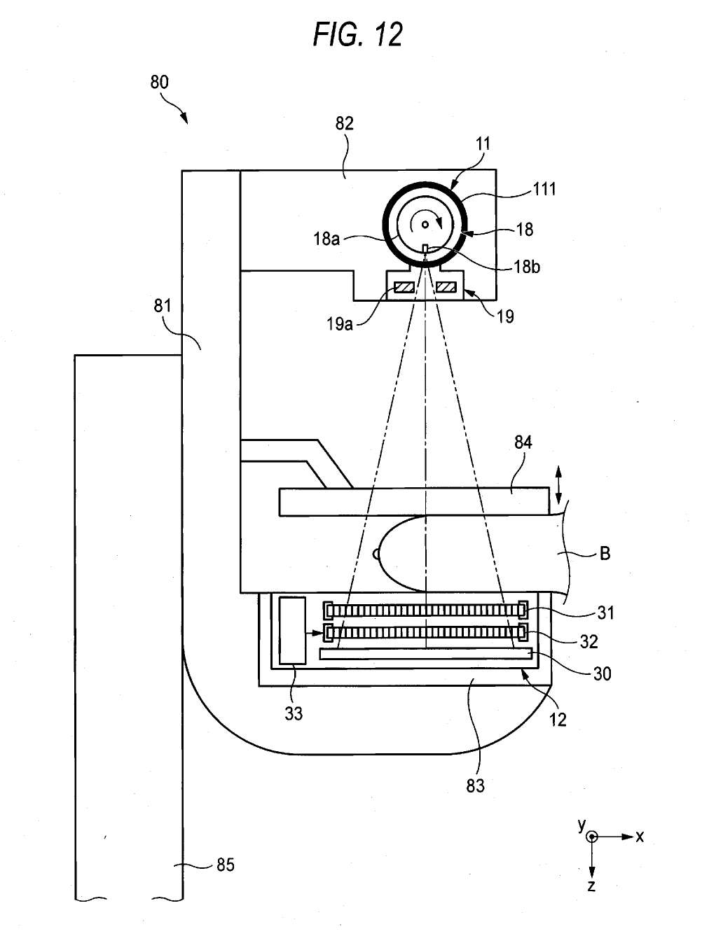

FIG. 12 shows another example of a configuration of a radiographic system for illustrating an illustrative embodiment of the invention.

A mammography apparatus 80 shown in FIG. 12 is an apparatus that captures an X-ray image (phase contrast image) of the breast B that is an object to be diagnosed. The mammography apparatus 80 includes an X-ray source accommodation unit 82 that is provided to one end of an arm member 81 rotatably connected to a base platform 85, an imaging platform 83 that is provided to the other end of the arm member 81 and a compression plate 84 that is adapted to vertically move relative to the imaging platform 83.

The X-ray source 11 is accommodated in the X-ray source accommodation unit 82 and the imaging unit 12 is accommodated in the imaging platform 83. The X-ray source 11 whose housing 18 is surrounded by the vibration-proof materials 111 over the entire circumference thereof is accommodated in the X-ray source accommodation unit 82. Also, the cooling unit 15 having the fan for cooling the X-ray tube is attached to the housing 18. Thereby, even when the vibration is generated in the X-ray source 11 in association with the rotation of the rotary anode 18a or fan of the cooling unit 15, it is possible to prevent the vibration from being transferred to the first and second absorption type gratings 31, 32 and the FPD 30 of the imaging unit 12 through the arm member 81. Also, the X-ray source 11 and the imaging unit 12 are opposed to each other. The compression plate 84 is moved by a moving mechanism (not shown), thereby pressing the breast B between the imaging platform 83 and the compression plate 84. At this pressing state, the X-ray imaging is performed.

Like the above illustrative embodiments, the buffer material 77 that prevents or reduces the vibration to be transferred from the bottom is provided between the base platform 85 and the bottom. Also, the dynamic damper 76 that prevents or reduces the vibration to be transferred to the base platform 85 is provided to the base platform 85.

Also, since the X-ray source 11 and the imaging unit 12 have the same configurations as the above illustrative embodiments, the respective constitutional elements are indicated with the same reference numerals. Since the other configurations and effects are the same as the above illustrative embodiments, the descriptions thereof are omitted.

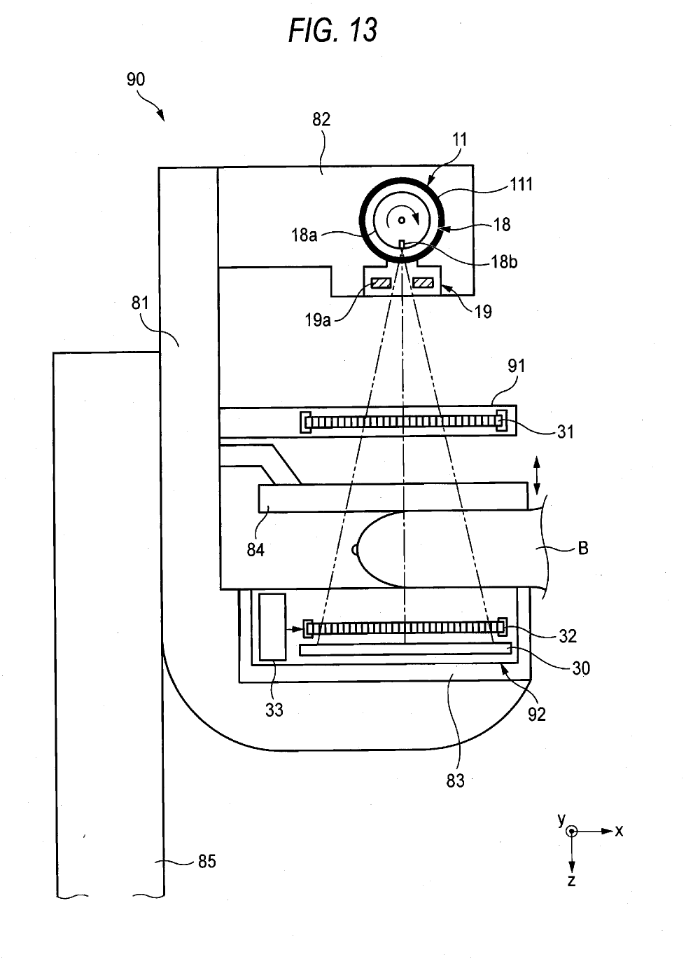

FIG. 13 shows a modified embodiment of the radiographic system of FIG. 12.

A mammography apparatus 90 shown in FIG. 13 is different from the mammography apparatus 80 in that the first absorption type grating 31 is provided between the X-ray source 11 and the compression plate 84. The first absorption type grating 31 is accommodated in a grating accommodation unit 91 that is connected to the arm member 81. An imaging unit 92 is configured by the FPD 30, the second absorption type grating 32 and the scanning mechanism 33.

Like this, even when the object to be diagnosed (breast) B is positioned between the first absorption type grating 31 and the second absorption type grating 32, the projection image (G1 image) of the first absorption type grating 31, which is formed at the position of the second absorption type grating 32, is deformed by the object to be diagnosed B. Accordingly, also in this case, it is possible to detect the moiré fringe, which is modulated due to the object to be diagnosed B, by the FPD 30. That is, also with the mammography apparatus 90, it is possible to obtain the phase contrast image of the object to be diagnosed B by the above-described principle.

In the mammography apparatus 90, since the X-ray whose radiation dose has been substantially halved by the shielding of the first absorption type grating 31 is irradiated to the object to be diagnosed B, it is possible to decrease the radiation exposure amount of the object to be diagnosed B about by half, compared to the mammography apparatus 80. In the meantime, like the mammography apparatus 90, the configuration in which the object to be diagnosed is arranged between the first absorption type grating 31 and the second absorption type grating 32 can be applied to the above X-ray imaging system 70.

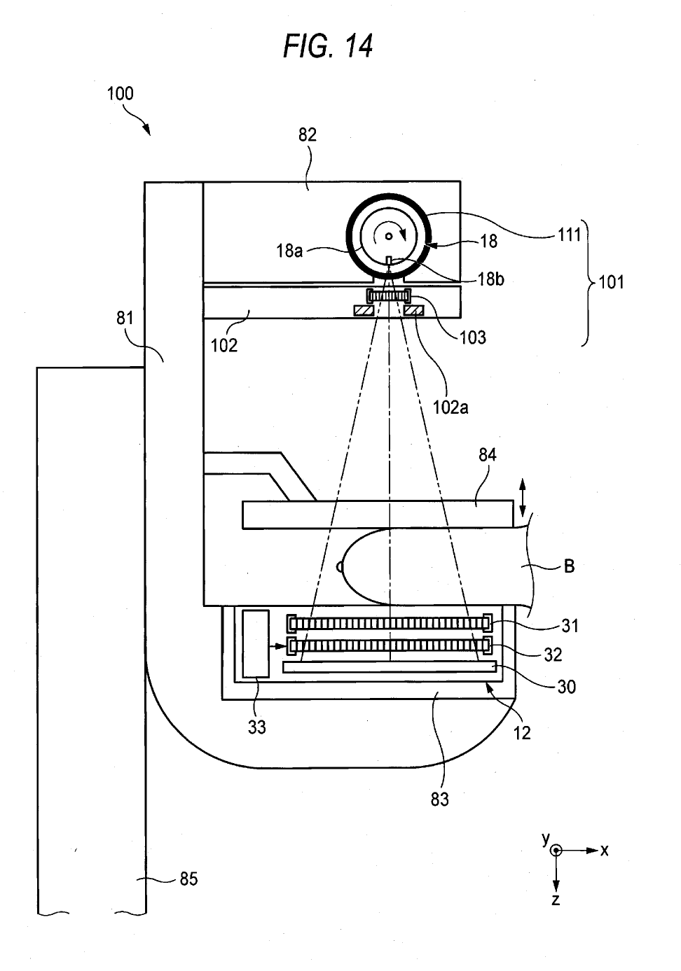

FIG. 14 shows a modified embodiment of the radiographic system of FIG. 12.

A mammography apparatus 100 of FIG. 14 is different from the mammography apparatus 80 in that a collimator 102a and a multi-slit 103 are accommodated in a collimator unit accommodation unit 102 different from the X-ray source accommodation unit 82.

In the above illustrative embodiment, when the distance from the X-ray source 11 to the FPD 30 is set to be same as a distance (1 to 2 m) that is set in an imaging room of a typical hospital, the blurring of the G1 image may be influenced by a focus size (in general, about 0.1 mm to 1 mm) of the X-ray focus 18b, so that the quality of the phase contrast image may be deteriorated. Accordingly, it may be considered that a pin hole is provided just after the X-ray focus 18b to effectively reduce the focus size. However, when an opening area of the pin hole is decreased so as to reduce the effective focus size, the X-ray intensity is lowered. In this illustrative embodiment, in order to solve this problem, the multi-slit 103 is arranged just after the X-ray focus 18b.

The multi-slit 103 is an absorption type grating (i.e., third absorption grating) having the same configuration as the first and second absorption type gratings 31, 32 provided to the imaging unit 12 and has a plurality of X-ray shield units extending in one direction (y direction, in this illustrative embodiment), which are periodically arranged in the same direction (x direction, in this illustrative embodiment) as the X-ray shield units 31b, 32b of the first and second absorption type gratings 31, 32. The multi-slit 103 is to partially shield the radiation from the X-ray source 11, thereby reducing the effective focus size in the x direction and forming a plurality of point light sources (disperse light sources) in the x direction.

It is necessary to set a grating pitch p3 of the multi-slit 103 so that it satisfies a following equation (19), when a distance from the multi-slit 103 to the first absorption type grating 31 is L3.

$$\begin{matrix}[ equation 19 ] & \\ {p}_{3} = \frac{{L}_{3}}{{L}_{2}} {p}_{2} & ( 19 )\end{matrix}$$

Also, in this illustrative embodiment, since the position of the multi-slit 103 is substantially the X-ray focus position, the grating pitch p2 and the interval d2 of the second absorption type grating 32 are determined to satisfy following equations (20) and (21).

$$\begin{matrix}[ equation 20 ] & \\ {p}_{2} = \frac{{L}_{3} + {L}_{2}}{{L}_{3}} {p}_{1} & ( 20 ) \\ [ equation 21 ] & \\ {d}_{2} = \frac{{L}_{3} + {L}_{2}}{{L}_{3}} {d}_{1} & ( 21 )\end{matrix}$$

Also, in this illustrative embodiment, when it is intended to secure a length V of the effective field of view in the x direction on the detection surface of the FPD 30, the thickness h1, h2 of the X-ray shield units 31b, 32b of the first and second absorption type gratings 31, 32 are determined to satisfy following equations (22) and (23) when a distance from the multi-slit 103 to the detection surface of the FPD 30 is L′.

$$\begin{matrix}[ equation 22 ] & \\ {h}_{1} \leq \frac{{L}^{′}}{V / 2} {d}_{1} & ( 22 ) \\ [ equation 23 ] & \\ {h}_{2} \leq \frac{{L}^{′}}{V / 2} {d}_{2} & ( 23 )\end{matrix}$$

The equation (19) is a geometrical condition so that the projection image (G1 image) of the X-ray, which is emitted from the respective point light sources dispersedly formed by the multi-slit 103, by the first absorption type grating 31 coincides (overlaps) at the position of the second absorption type grating 32. Like this, in this illustrative embodiment, the G1 image based on the point light sources formed by the multi-slit 103 overlaps, so that it is possible to improve the quality of the phase contrast image without lowering the X-ray intensity.

Also, in this illustrative embodiment, the collimator unit accommodation unit 102 that is connected to the arm member 81 accommodates therein the multi-slit 103 and the collimator 102a. By providing the collimator unit accommodation unit 102 separately from the X-ray source accommodation unit 82, the vibrations of the rotary anode 18a and the fan of the cooling unit 15 are not transferred to the multi-slit 103 well. Thereby, it is possible to prevent the quality improving effect of the phase contrast image by the multi-slit 103 from being lowered.

Meanwhile, the multi-slit 103 as described above can be applied to any of the above illustrative embodiments.

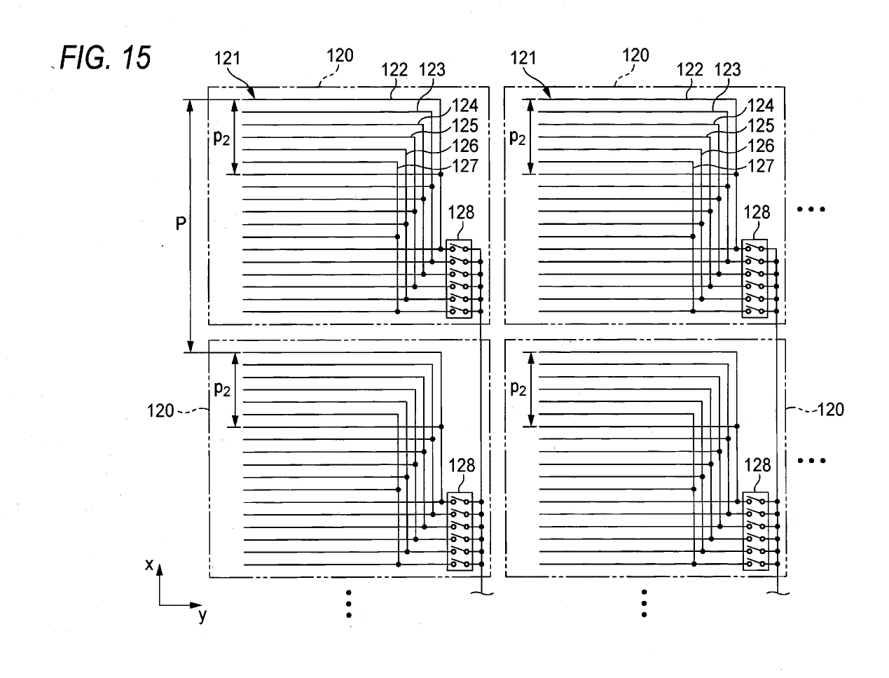

FIG. 15 shows another example of a radiographic system for illustrating an illustrative embodiment of the invention, in which a configuration of the radiological image detector thereof is shown.

In the X-ray imaging system 70, the second absorption type grating 32 is independently provided of the FPD 30. However, the second absorption type grating may be excluded by using an X-ray image detector having a configuration disclosed in JP-A-2009-133823. The X-ray image detector is a direct conversion type X-ray image detector that includes a conversion layer, which converts the X-ray into charges, and a charge collection electrode, which collects the charges converted by the conversion layer. A charge collection electrode 121 of each pixel 120 is configured by a plurality of linear electrode groups 122 to 127 so that phases thereof are different, each of the groups consists of a plurality of linear electrodes arranged with a constant period and electrically connected to each other.

The pixels 120 are two-dimensionally arranged with a constant pitch in the x and y directions. Each pixel 120 is formed with the charge collection electrode 121 for collecting charges converted by the conversion layer that converts the X-ray into charges. The charge collection electrode 121 has the first to sixth linear electrode groups 122 to 127. The respective linear electrode groups are offset by π/3 with respect to a phase of an arrangement period of the linear electrodes. Specifically, when a phase of the first linear electrode group 122 is 0, a phase of the second linear electrode group 123 is π/3, a phase of the third linear electrode group 124 is 2π/3, a phase of the fourth linear electrode group 125 is π, a phase of the fifth linear electrode group 126 is 4π/3 and a phase of the sixth linear electrode group 127 is 5π/3.

In each of the first to sixth linear electrode groups 122 to 127, the linear electrodes extending in the y direction are periodically arranged with a predetermined pitch p₂ in the x direction. A relation of a substantial pitch p₂′ (a substantial pitch after the manufacturing) of the arrangement pitch p₂ of the linear electrodes, a pattern period p₁′ of the G1 image at a position (a position of the X-ray image detector) of the charge collection electrode 121 and an arrangement pitch P of the pixels 120 in the x direction is necessary to satisfy the equation (8), based on the period T of the moiré fringe expressed by the equation (7) and preferably to satisfy the equation (9), like the second absorption type grating 32 of the X-ray imaging system 70.

Furthermore, each of the pixels 120 is provided with a switch group 128 for reading out the charges collected by the charge collection electrode 121. The switch group 128 consists of TFT switches each of which is provided to the first to sixth linear electrode groups 121 to 126, respectively. The charges collected by the first to sixth linear electrode groups 121 to 126 are individually read out under control of the switch groups 128, so that it is possible to acquire six fringe images having different phases by one imaging and to generate the phase contrast image based on the six fringe images.

When the X-ray image detector having the above configuration is applied to the X-ray imaging system 70, the second absorption type grating 32 is not necessary for the imaging unit 12. Also, since it is possible to acquire the fringe images having a plurality of phase components by one imaging, the physical scanning for the fringe scanning is not required, so that the scanning mechanism 33 can be excluded. Thereby, it is possible to reduce the cost and to make the imaging unit further smaller. In the meantime, regarding the configuration of the charge collection electrode, the other configuration as disclosed in JP-A-2009-133823 may be used instead of the above configuration.

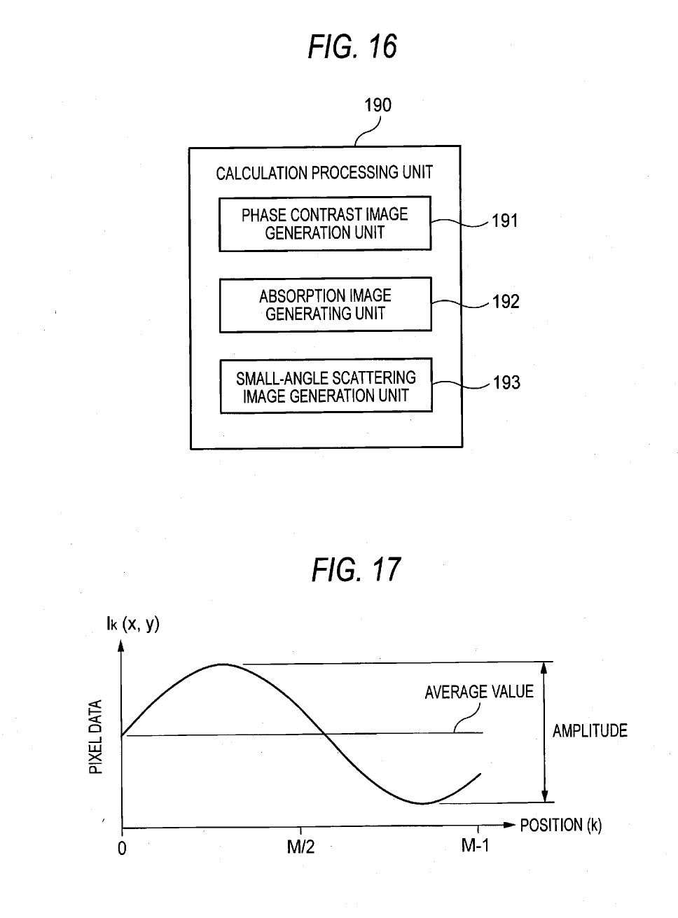

FIG. 16 is a block diagram showing a configuration of a calculation unit that generates a radiological image, in accordance with another example of a radiographic system for illustrating an illustrative embodiment of the invention.

According to the respective X-ray imaging systems, it is possible to acquire a high contrast image (phase contrast image) of an X-ray weak absorption object that cannot be easily represented. Further, to refer to the absorption image in correspondence to the phase contrast image is helpful to the image reading. For example, it is effective to superimpose the absorption image and the phase contrast image by the appropriate processes such as weighting, gradation, frequency process and the like and to thus supplement a part, which cannot be represented by the absorption image, with the information of the phase contrast image. However, when the absorption image is captured separately from the phase contrast image, the capturing positions between the capturing of the phase contrast image and the capturing of the absorption image are deviated to make the favorable superimposition difficult. Also, the burden of the object to be diagnosed is increased as the number of the imaging is increased. In addition, in recent years, a small-angle scattering image attracts attention in addition to the phase contrast image and the absorption image. The small-angle scattering image can represent a tissue characterization caused due to the fine structure in the photographic subject tissue. For example, in fields of cancers and circulatory diseases, the small-angle scattering image is expected as a representation method for a new image diagnosis.

Accordingly, the X-ray imaging system of this illustrative embodiment uses a calculation processing unit 190 that enables the absorption image and the small-angle scattering image to be generated from a plurality of images acquired for the phase contrast image. Since the other configurations are the same as the above X-ray imaging system 70, the descriptions thereof are omitted. The calculation processing unit 190 has a phase contrast image generation unit 191, an absorption image generation unit 192 and a small-angle scattering image generation unit 193. The units perform the calculation processes, based on the image data acquired at the M scanning positions of k=0, 1, 2, . . . , M−1. Among them, the phase contrast image generation unit 191 generates a phase contrast image in accordance with the above-described process.

The absorption image generation unit 192 averages the image data Ik(x, y), which is obtained for each pixel, with respect to k, as shown in FIG. 17, and thus calculates an average value and images the image data, thereby generating an absorption image. Also, the calculation of the average value may be performed by averaging the image data Ik(x, y) with respect to k. However, when M is small, an error is increased. Accordingly, after fitting the image data Ik(x, y) with a sinusoidal wave, an average value of the fitted sinusoidal wave may be calculated. In addition, when generating the absorption image, the invention is not limited to the using of the average value. For example, an addition value that is obtained by adding the image data Ik(x, y) with respect to k may be used inasmuch as it corresponds to the average value.

The small-angle scattering image generation unit 193 calculates an amplitude value of the image data Ik(x, y), which is obtained for each pixel, and thus images the image data, thereby generating a small-angle scattering image. Also, the amplitude value may be calculated by calculating a difference between the maximum and minimum values of the image data Ik(x, y). However, when M is small, an error is increased. Accordingly, after fitting the image data Ik(x, y) with a sinusoidal wave, an amplitude value of the fitted sinusoidal wave may be calculated. In addition, when generating the small-angle scattering image, the invention is not limited to the using of the amplitude value. For example, a variance value, a standard error and the like may be used as an amount corresponding to the non-uniformity about the average value.

According to the X-ray imaging system of this illustrative embodiment, the absorption image or small-angle scattering image is generated from the plurality of images acquired for the phase contrast image of the photographic subject. Accordingly, the capturing positions between the capturing of the phase contrast image and the capturing of the absorption image are not deviated, so that it is possible to favorably superimpose the phase contrast image and the absorption image or small-angle scattering image. Also, it is possible to reduce the burden of the photographic subject, compared to a configuration in which the imaging is separately performed so as to acquire the absorption image and the small-angle scattering image.

As described above, the specification discloses a radiographic apparatus that includes a radiation source that irradiates radiation, a first grating that enables the radiation irradiated from the radiation source to pass therethrough, a grating pattern having a period that substantially coincides with a pattern period of a radiological image formed by the radiation having passed through the first grating, a radiological image detector that detects the radiological image masked by the grating pattern, and a support unit that supports the radiation source, the first grating, the grating pattern and the radiological image detector, in which the radiation source is attached to the support unit via a vibration-proof member.

Also, according to the radiographic apparatus disclosed in the specification, the grating pattern is located at a plurality of relative positions having different phases with respect to the radiological image.

Also, according to the radiographic apparatus disclosed in the specification, the grating pattern is a second grating, and the radiographic apparatus further includes a scanning mechanism that moves one of the first grating and the second grating and thus locates the second grating at the plurality of relative positions with respect to the radiological image.

Also, according to the radiographic apparatus disclosed in the specification, the radiological image detector includes a conversion layer that converts the radiation into charges and a charge collection electrode that collects the charges converted by the conversion layer, for each pixel, the charge collection electrode has a plurality of linear electrode groups each of which has a period substantially coinciding with the pattern period of the radiological image, the linear electrode groups are arranged so that phases thereof are different from each other, and the grating pattern is configured by each of the linear electrode groups.

Also, according to the radiographic apparatus disclosed in the specification, the radiographic apparatus further includes a third grating that enables the radiation irradiated from the radiation source to selectively pass regarding an area and irradiates the same to the first grating, and the third grating is supported to the support unit.

Also, according to the radiographic apparatus disclosed in the specification, the radiation source has an X-ray tube that collides an electron beam with a rotary anode being rotating at predetermined speed and thus generates an X-ray.

Also, according to the radiographic apparatus disclosed in the specification, the vibration-proof member has a plurality of annular vibration-proof materials, the support unit has a plurality of annular holding parts and the X-ray tube of the radiation source is held by the plurality of holding parts via the plurality of vibration-proof materials.

Also, according to the radiographic apparatus disclosed in the specification, the support unit has an arm that supports the radiation source, the first grating, the grating pattern and the radiological image detector, a base platform that supports the arm and is mounted on a bottom and a vibration-proof part that reduces vibration to be transferred to the base platform.

Also, according to the radiographic apparatus disclosed in the specification, the vibration-proof part has a buffer material that is interposed between the bottom and the base platform.

Also, according to the radiographic apparatus disclosed in the specification, the vibration-proof part has a dynamic damper that is provided to the base platform.

Also, the specification discloses a radiographic system that includes the radiographic apparatus described with respect to any of the above apparatuses and a calculation unit that calculates, from an image detected by the radiological image detector of the radiographic apparatus, a distribution of refraction angles of the radiation incident onto the radiological image detector and generates a phase contrast image of a photographic subject based on the distribution of the refraction angles.

What is claimed is:

1. A radiographic apparatus comprising:
a radiation source that irradiates radiation;
a first grating unit through which the radiation irradiated from the radiation source passes;
a grating pattern unit that includes a periodic form that has a period which substantially coincides with a pattern period of a radiological image formed by the radiation having passed through the first grating unit;
a radiological image detector that detects a masked radiological image which is formed by masking the radiological image by the grating pattern unit, and
a support unit that supports the radiation source, the first grating unit, the grating pattern unit and the radiological image detector,
wherein the radiation source is attached to the support unit via a vibration-proof member.

2. The radiographic apparatus according to claim 1, wherein the grating pattern unit is located at a plurality of relative positions having different phases with respect to the radiological image.

3. The radiographic apparatus according to claim 1, wherein the grating pattern unit is a second grating unit, and
further comprising a scanning unit that relatively moves one of the first grating unit and the second grating unit in order to locate the second grating unit at the plurality of relative positions with respect to the radiological image.

4. The radiographic apparatus according to claim 1, wherein the radiological image detector includes a conversion layer that converts the radiation into charges and a charge collection electrode that collects the charges converted by the conversion layer, for each pixel,
the charge collection electrode has a plurality of linear electrode groups each of which has a period substantially coinciding with the pattern period of the radiological image,
the linear electrode groups are arranged so that phases thereof are different from each other, and
the grating pattern unit is formed by each of the linear electrode groups.

5. The radiographic apparatus according to claim 1, further comprising a third grating unit that allows the radiation irradiated from the radiation source to selectively pass regarding an area and irradiates the passing radiation to the first grating unit, and
wherein the third grating unit is supported to the support unit.

6. The radiographic apparatus according to claim 1, wherein the radiation source has an X-ray tube that collides an electron beam with a rotary anode being rotating at predetermined speed to generate an X-ray.

7. The radiographic apparatus according to claim 6, wherein the vibration-proof member has a plurality of annular vibration-proof materials,
the support unit has a plurality of annular holding parts, and
the X-ray tube of the radiation source is held by the plurality of holding parts via the plurality of vibration-proof materials.

8. The radiographic apparatus according to one of claim 1, wherein the support unit has an arm that supports the radiation source, the first grating unit, the grating pattern unit and the radiological image detector, a base platform that supports the arm and is mounted on a bottom and a vibration-proof part that reduces vibration to be transferred to the base platform.

9. The radiographic apparatus according to claim 8, wherein the vibration-proof part has a buffer material that is interposed between the bottom and the base platform.

10. The radiographic apparatus according to claim 8, wherein the vibration-proof part has a dynamic damper that is provided to the base platform.

11. A radiographic system comprising:
the radiographic apparatus according to claim 1, and
a calculation processing unit that calculates, from an image detected by the radiological image detector of the radiographic apparatus, a distribution of refraction angles of the radiation incident onto the radiological image detector and generates a phase contrast image of a photographic subject based on the distribution of the refraction angles.
